(19) United States
(12) Patent Application Publication
(10) Pub. No.: US 2006/0056859 A1
(43) Pub. Date: Mar. 16, 2006

(54) Image forming apparatus, image forming method, and computer product

(76) Inventor: Masaki Otani, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/224,977

(22) Filed: Sep. 14, 2005

(30) Foreign Application Priority Data
Sep. 16, 2004 (JP) 2004-270445
Aug. 19, 2005 (JP) 2005-238821

(51) Int. Cl. G03G 15/00

(52) U.S. Cl. 399/16

(57) ABSTRACT

An image forming apparatus performs image formation based on a first parameter concerning the image forming apparatus itself. When a parameter extracted from data received from an information processing apparatus corresponds to a second parameter concerning another image forming apparatus, the image forming apparatus converts the extracted parameter to the first parameter according to information stored in the image forming apparatus. The information includes the first parameter associated with the second parameter.

### CROSS-REFERENCE TO RELATED APPLICATIONS

The present document incorporates by reference the entire contents of Japanese priority document, 2004-270445 filed in Japan on Sep. 16, 2004 and 2005-238821 filed in Japan on Aug. 19, 2005.

### BACKGROUND OF THE INVENTION

1. Field of the Invention

The present invention relates to a technology for performing an image formation processing by setting options.

2. Description of the Related Art

Image forming apparatuses such as a printer, a digital copying machine, and a multifunction peripheral having functions of a printer, a copying machine, a facsimile, a scanner integrated therein are widely used nowadays. Some of the image forming apparatuses are configured to receive print data from a host computer, which can be connected to the image forming apparatus through a network, and perform printing based on the print data. The print data includes printing options apart from data to be printed (see, for example, Japanese Patent Application Laid-open No. 2004-34636). A printer driver is installed in the host computer. When printing data created by an application, such as a word processor, in the host computer, various options can be set, such as a sheet feeding tray, a sheet discharge tray, a print font, and a form overlay.

The printer driver creates print data described in a Page Description Language (PDL) from the data to be printed, which is created by the application, and transmits the print data to the image forming apparatus. The PDL is a printer control code (language) for creating a print image in a page printer. There are printer control codes for printing characters, and printer control codes for rendering images such as graphics. The printer control codes do not depend on the type of image forming apparatus. Typical page description languages include PostScript (registered trademark), HP-PCL (registered trademark), LIPS (registered trademark), ESC/Page (registered trademark), and PRESCRIBE (registered trademark).

In print data described in the page description languages (hereinafter referred to as “PDL data”), settings of the printing options are described as environment variable parameters.

The image forming apparatus analyzes (interprets) the PDL data received from the host computer, reads the environment variable parameters such as the sheet feeding tray, the sheet discharge tray, the print font, and the form overlay, and performs print processing according to settings corresponding to the environment variable parameters. For example, values of environment variable parameters of a tray 1, a sheet discharge tray 2, and a Roman font are described in the PDL data as options of the sheet feeding tray, the sheet discharge tray, and the print font, respectively. In this case, the image forming apparatus performs print processing to feed a sheet from the tray 1, performs image formation with the Roman font, and discharges the sheet subjected to the image formation from the sheet discharge tray 2.

Language specifications for the page description languages are standardized and do not depend on image forming apparatuses manufactured by different manufacturers. However, values of the environment variable parameters specifying the sheet feeding tray, the sheet discharge tray, the print font, and the form overlay differ according to the manufacturer. Therefore, when an image forming apparatus of a certain manufacturer is replaced with a new image forming apparatus of another manufacturer, a printer driver corresponding to the new image forming apparatus needs to be installed in the host computer. However, a user may wish to continue using a printer driver of the former image forming apparatus, without installing the printer driver corresponding to the new image forming apparatus.

In other words, when an image forming apparatus is replaced with an image forming apparatus of a different model, allocation of sheet feeding tray numbers of the latter image forming apparatus is not always the same as that of the former image forming apparatus. However, it is more convenient if the user can continue using the same sheet feeding tray numbers.

In addition, when an image forming apparatus is replaced with an image forming apparatus of a different model, operations of selecting sheet feeding trays might be different. For example, when the user designates a sheet feeding tray, some image forming apparatuses select the designated sheet feeding tray while others automatically search for a sheet feeding tray giving priority to a size of a sheet.

### SUMMARY OF THE PRESENT INVENTION

It is an object of the present invention to at least solve the problems in the conventional technology.

According to an aspect of the present invention, an image forming apparatus includes a storing unit that stores therein information including a first parameter concerning the image forming apparatus associated with a second parameter concerning another image forming apparatus, an extracting unit that extracts a parameter from data received from an information processing apparatus, a converting unit that converts, when the parameter extracted by the extracting unit corresponds to the second parameter, extracted parameter to the first parameter based on the information stored in the storing unit, and an image formation unit that performs image formation according to the first parameter.

According to another aspect of the present invention, a method of forming an image includes storing information including a first parameter concerning an image forming apparatus associated with a second parameter concerning another image forming apparatus, extracting a parameter from data received from an information processing apparatus, converting, when the parameter extracted at the extracting corresponds to the second parameter, extracted parameter to the first parameter based on the information stored at the storing, and performing image formation according to the first parameter.

According to still another aspect of the present invention, a computer-readable recording medium stores therein a computer program that implements a method according to the present invention on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram of an image forming system according to an embodiment of the present invention;

FIG. 2 is a block diagram of a hardware configuration of a printer controller provided in a printer shown in FIG. 1;

FIG. 3 is a block diagram of an image forming unit shown in FIG. 2;

FIG. 4 is a functional block diagram of a printer application;

FIG. 5A is an environment variable parameter table including parameter values used in a printer before replacement;

FIG. 5B is an environment variable parameter table including parameter values used in a new printer after replacement;

FIG. 6 is a conversion table including the parameter values used in the printer before replacement associated with the parameter values used in the new printer;

FIG. 7 is a flowchart of a processing procedure performed by the printer; and

FIG. 8 is a schematic of a screen for setting environment variable parameter conversion displayed on a WEB browser.

### DETAILED DESCRIPTION OF THE PREFERRED EMBODIMENTS

Exemplary embodiments of the present invention will be described below with reference to accompanying drawings. The present invention is not limited to these embodiments.

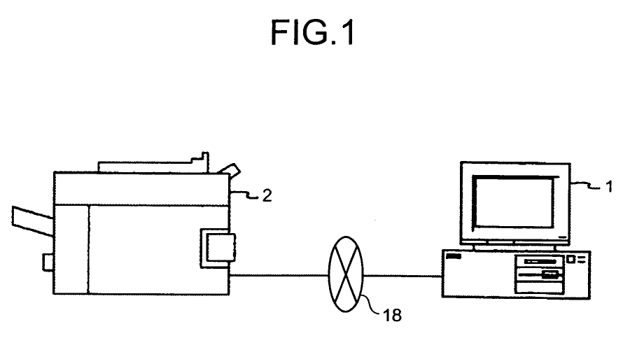

FIG. 1 is a diagram of an image forming system according to an embodiment of the present invention. The image forming system includes a host computer 1 and a printer 2 that are connected via a network 18. The network 18 can be the Internet. The host computer 1 and the printer 2 can be connected directly using a cable.

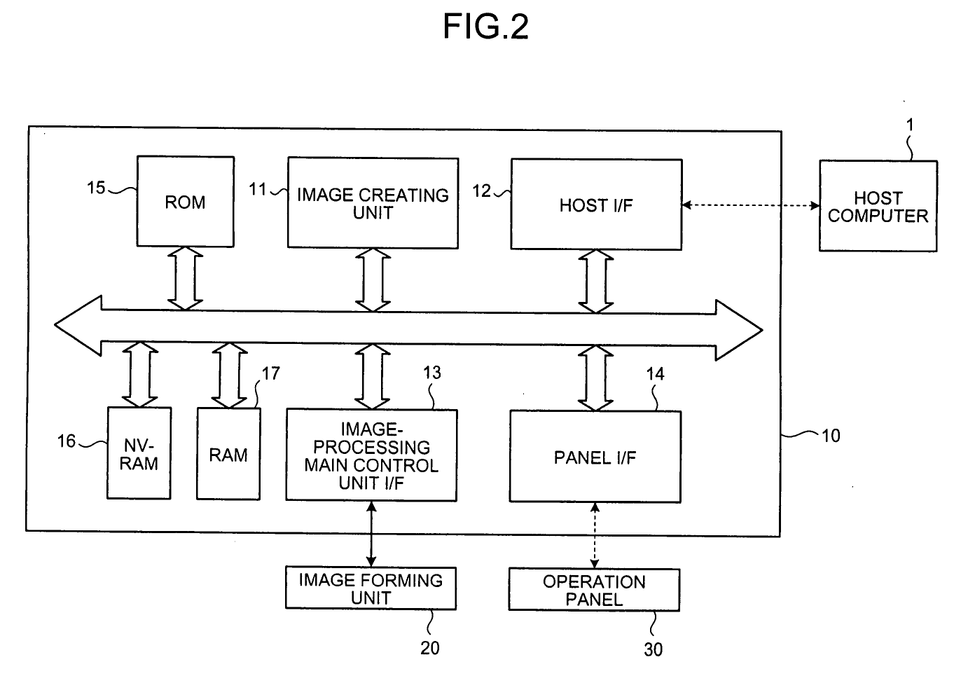

The printer 2 includes a printer controller 10. FIG. 2 is a block diagram of a hardware configuration of the printer controller 10. The printer controller 10 includes an image creating unit 11, a host interface (I/F) 12, an image-processing main control unit I/F 13, a panel I/F 14, a Read Only Memory (ROM) 15, a Random Access Memory (RAM) 17, and a NonVolatile RAM (NV-RAM) 16.

The host I/F 12 is connected to the host computer 1. The image-processing main control unit I/F 13 is connected to an image forming unit 20. The panel I/F 14 is connected to an operation panel 30.

The host I/F 12 transmits data to and receives data from the host computer 1. The host I/F 12 informs the host computer 1 of a state of the printer 2 and receives print data of a document created by the host computer 1. The print data includes commands described in a page description language (hereinafter referred to as “PDL data”). The PDL data specifies a sheet feeding tray, a sheet discharge tray, a font for printing, and a form for overlay printing that are designated by an application running on the host computer 1 when printing is performed. The PDL data is interpreted and expanded into image data by the image creating unit 11.

The image-processing main control unit I/F 13 controls image processing for the image data expanded by the image creating unit 11 and delivery of the image data between the printer controller 10 and the image forming unit 20. In other words, when the image creating unit 11 completes creation of image data for one page, the image-processing main control unit I/F 13 delivers an image to the image forming unit 20 together with the image data designating a sheet feeding stage, a sheet discharge processing method, and the like.

The operation panel 30 receives various settings like printing conditions input by a user. The operation panel 30 includes a display unit (not shown) and an operation unit (not shown). The display unit can be a liquid crystal display and the operating unit can be a keyboard. On the other hand, the display unit and the operating unit can be integrated together as in a touch screen. A user inputs instructions or data via the operating unit while looking at the contents displayed on the display unit. The panel I/F 14 controls display of the screens on the operation panel 30 and operation input from the operation panel 30.

A printer application, which is a computer program, is stored in the ROM 15. The RAM 17 stores therein various data temporarily. When the printer application is executed, a module constituting the printer application is expanded as units. The NV-RAM 16 is a nonvolatile memory like a flash memory. A conversion table and an environment variable parameter table are stored in the NV-RAM 16.

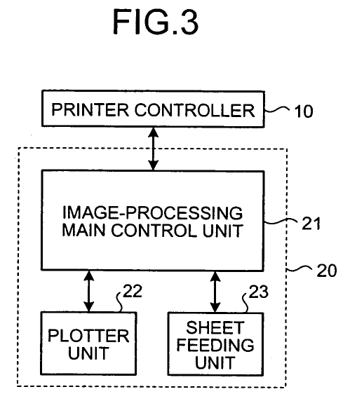

As shown in FIG. 3, the image forming unit 20 includes an image-processing main control unit 21, a plotter unit 22, and a sheet feeding unit 23. The sheet feeding unit 23 performs sheet feeding control and sheet discharge control in response to an instruction of the printer controller 10. The plotter unit 22 visualizes image data delivered from the printer controller 10 to obtain an image and transfers and fixes the image on a sheet while controlling timing. The image-processing main control unit 21 controls transmission and reception of data and instructions between the printer controller 10 and the plotter unit 22 and the sheet feeding unit 23.

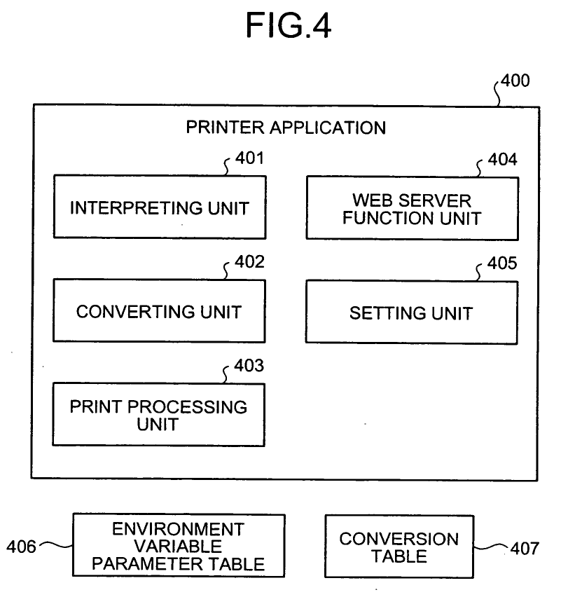

FIG. 4 is a functional block diagram of an exemplary printer application 400. The printer application 400 includes an interpreting unit 401, a converting unit 402, a print processing unit 403, a WEB server function unit 404, and a setting unit 405. The printer application 400 accesses an environment variable parameter table 406 and a conversion table 407 stored in the NV-RAM 16.

The interpreting unit 401 receives PDL data generated by the host computer 1 via the host I/F 12 and interprets commands described in the PDL data to extract parameter values of environment variables included in the PDL data. Parameters of the environment variables define printing conditions for the printer 2. Specifically, the parameters are numerical parameters indicating a type of a sheet feeding tray (a tray 1, a tray 2, etc.), a type of a sheet discharge tray (a sheet discharge tray 1, a sheet discharge tray 2, etc.), a type of a font for printing, such as Roman, Gothic, etc., and a type of a form to be overlaid, such as form 1, form 2, etc.). When a description in the PDL data is, for example, ‘sheet feeding tray=“11”, sheet discharge tray=“21”, font=“31”, overlay=“42”’, the interpreting unit 401 extracts “11”, “21”, “31”, and “42” from the PDL data as parameter values.

The converting unit 402 converts the parameter values extracted into parameter values corresponding to another printer according to the conversion table 407. The parameter values may be different according to the manufacturer of printers. For example, it is possible that the parameter value “11” for a sheet feeding tray indicates the tray 1 in a printer of a certain manufacturer and indicates the tray 2 in a printer of another manufacturer. Some printers allow loading of sheets of different sizes in tray 1.

Conventionally, when a printer is replaced with a new printer of another manufacturer, a printer driver corresponding to the new printer is installed in the host computer 1. However, some users prefer to continue using a printer driver of the former printer. In this case, since parameter values of environment variables represent different settings according to the manufacturer of the printer, an undesired sheet or font might be applied to the print output. Even when the same parameter value “11” indicates the tray 1 in both the former printer and the new printer, the size of sheets contained in the tray 1 of the former printer may be different to that of the new printer. In such a case, an undesired sheet size is applied to the print output. As a result, generally the users can not continue using the printer driver of the former printer.

To solve this problem, the printer 2 includes the conversion table 407 that associates parameter values of a new printer with parameter values of a former printer. The converting unit 402 converts, according to the conversion table 407, parameter values of options designated by a printer driver corresponding to the former printer into parameter values of the new printer corresponding to the options of the former printer (conversion parameter information). Consequently, even when a former printer is replaced with the printer 2 as a new printer, it is possible to perform a print processing under the same printing conditions with a printer driver of the former printer, without installing a printer driver for the new printer.

The print processing unit 403 sets the parameter values of the new printer, which correspond to the options of the former printer. The converting unit 402 converts the parameter values of the former printer into the parameter values of the new printer to perform print processing.

The WEB server function unit 404 transmits an environment-variable-parameter setting screen to the host computer 1 through the network and causes the host computer 1 to display the environment-variable-parameter setting screen on a WEB browser. The WEB server function unit 404 receives parameter values designated by a user on the environment-variable-parameter setting screen from the host computer 1. The transmission of the environment-variable-parameter setting screen and the reception of the parameter values inputted on the environment-variable-parameter setting screen are performed according to the http protocol.

The setting unit 405 sets the parameter values received by the WEB server function unit 404 in the conversion table 407.

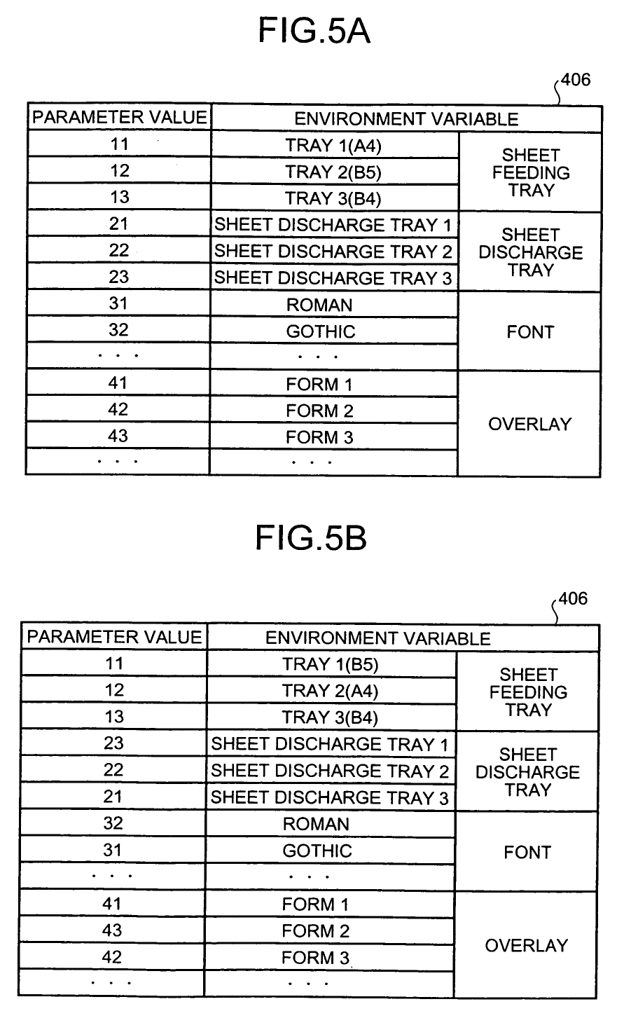

The environment variable parameter table 406 is a table that associates parameter values used in the printer 2 and environment variables (a sheet feeding tray, a sheet discharge tray, a font, a form overlay, etc.). FIG. 5A is the environment variable parameter table 406 that associates parameter values used in a former printer before replacement and environment variables. FIG. 5B is the environment variable parameter table 406 that associates parameter values used in a new printer after replacement and environment variables.

In the environment variable parameter table 406, the environment variables such as a tray 1, a tray 2, etc. are associated with parameter values such as “11”, “2”, etc.

Comparing the environment variable parameter table 406 of the former printer (FIG. 5A) and the environment variable parameter table 406 of the new printer (FIG. 5B), the parameter values of the environment variables are different as described below. Concerning the sheet feeding tray, both the tray 1 in the former printer and the tray 1 in the new printer has an identical parameter value “11”. However, whereas a sheet size of the tray 1 in the former printer is A4, a sheet size of the tray 1 in the new printer is B5. On the other hand, whereas a sheet size of the tray 2 in the former printer is B5, a sheet size of the tray 2 in the new printer is B5.

Concerning the sheet discharge tray, whereas a parameter value of a sheet discharge tray 1 is “21” in the former printer, the parameter value is “23” in the new printer. On the other hand, whereas a parameter value of a sheet discharge tray 3 is “23” in the former printer, the parameter value is “21” in the new printer.

Concerning the font for printing, whereas a parameter value of a Roman font is “31” in the former printer, the parameter value is “32” in the new printer. On the other hand, whereas a parameter value of a Gothic font is “32” in the former printer, the parameter value is “31” in the new printer.

Concerning the form overlay, whereas a parameter value of a form 2 is “42” in the former printer, the parameter value is “43” in the new printer. On the other hand, whereas a parameter value of a form 3 is “43” in the former printer, the parameter value is “42” in the new printer.

Therefore, when options at the time of printing are set as “the sheet feeding tray=the tray 1 (A4), the sheet discharge tray=the sheet discharge tray 1, the font=the Roman font, the form overlay=the form 2” from the host computer 1, since the host computer 1 uses the printer driver for the former printer, parameter values are ‘the sheet feeding tray=“11”, the sheet discharge tray=“21”, the font=“31”, the form overlay=“42”’. The parameter values are described in the PDL data. However, the parameter values of the environment variables are different between the former printer and the new printer. Thus, if the parameter values are set as described above, the opt-ions are “the sheet feeding tray=the tray 1 (B5), the sheet discharge tray=the sheet discharge tray 3, the font=the Gothic font, the form overlay=the form 3” from FIG. 5B. As a result, although the user wishes to perform printing with the sheet size of A4, the print font of the Roman font, and the form 2 overlaid in the sheet discharge tray 1, printing is performed in a completely different setting of options.

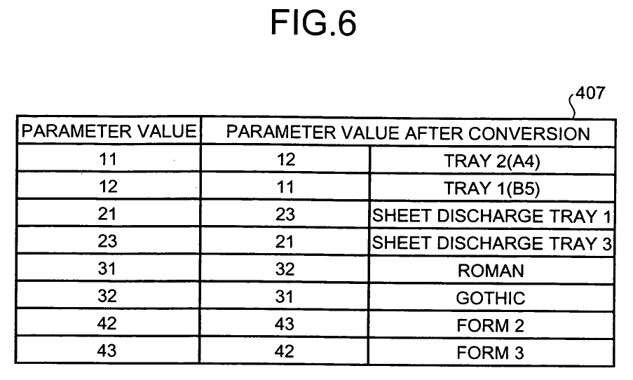

Therefore, in this embodiment, the parameter values of the former printer and the parameter values of the printer 2 (as the new printer) are associated with each other by the conversion table 407. FIG. 6 is an example of contents of the conversion table 407. In the example shown in FIG. 6, the environment variable parameters for the former printer shown in FIG. 5A and the environment variable parameters for the new printer shown in FIG. 5B are used.

The environment variable parameter table 406 of the former printer (FIG. 5A) and the environment variable parameter table 406 of the printer 2 after replacement (FIG. 5B) have the different parameter values as described above. Thus, the different parameter values are converted in the conversion table 407.

As shown in FIG. 6, the parameter value “11” (the tray 1 (A4)) of the former printer is associated with the parameter value “12” of the tray 2 (A4) that is the sheet feeding tray of the A4 size in the new printer. On the other hand, the parameter value “12” (the tray 2 (B5)) of the former printer is associated with the parameter value “11” of the tray 1 (B5) that is the sheet feeding tray of the B5 size in the new printer.

The parameter value “21” (the sheet discharge tray 1) of the former printer is associated with the parameter value “23” of the sheet discharge tray 1 in the new printer. On the other hand, the parameter value “23” (the sheet discharge tray 3) of the former printer is associated with the parameter value “21” of the sheet discharge tray 3 in the new printer.

The parameter value “131” (the Roman font) of the former printer is associated with the parameter value “32” of the Roman font in the new printer. On the other hand, the parameter value “32” (the Gothic font) of the former printer is associated with the parameter value “31” of the Gothic font in the new printer.

The parameter value “42” (the form 2) of the former printer is associated with the parameter value “43” of the form 2 in the new printer. On the other hand, the parameter value “43” (the form 3) of the former printer is associated with the parameter value “42” of the form 3 in the new printer.

By converting the parameter values according to the conversion table 407, the setting of the options designated by the user in the host computer 1 at the time of printing is reflected in the new printer 2 without replacing the printer driver. Note that it is possible to change the setting of the conversion table 407 from the host computer 1 and from the operation panel 30 of the printer 2.

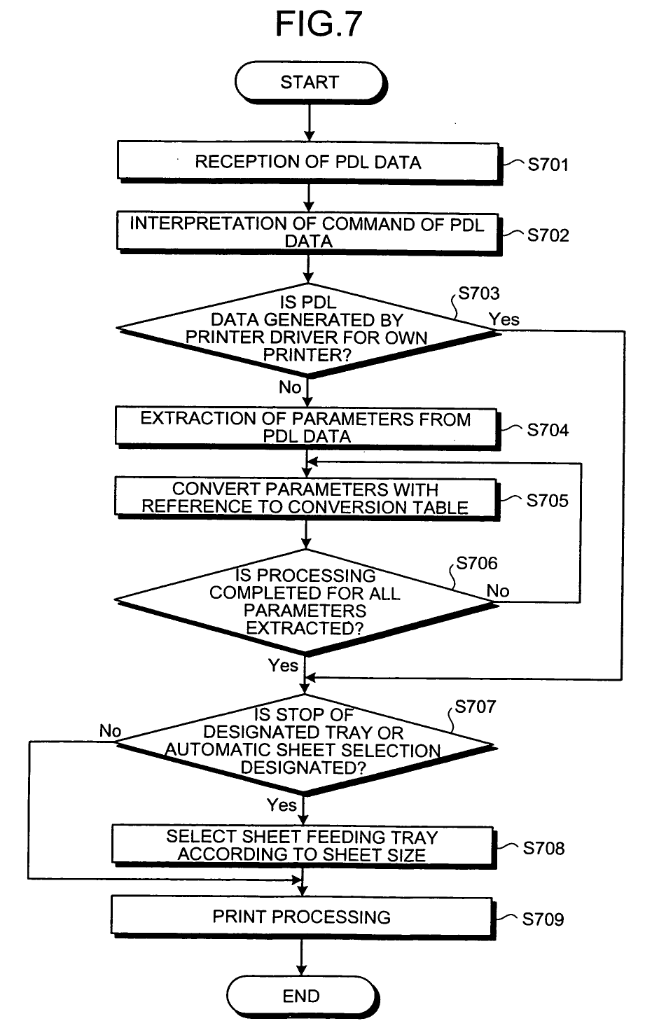

FIG. 7 is a flowchart of a print processing procedure performed by the printer 2.

A document or a picture is usually created by a certain application in the host computer 1 installed with the printer driver for the former printer. When the user designates printing, the printer driver is started to perform setting for printing.

The user designates setting of options such as a printing direction (portrait/landscape), a sheet size, a sheet feeding tray, a sheet discharge tray, a font, and a form overlay in a setting for the application or the printer driver. When start of printing is instructed, the printer driver generates PDL data serving as print command data that includes parameter values of rendering information such as font graphics and print coordinates thereof and apparatus control information including the setting of the options such as the sheet size, the sheet feeding tray, the sheet discharge tray, the font, and the form overlay. The host computer 1 transfers the PDL data to the printer 2 via the network 18.

The printer 2 receives the PDL data via the host I/F 12 (step S701) and interprets a command described in the PDL data using the interpreting unit 401 executed by the image creating unit 11 (step S702). Then, the printer 2 checks whether the PDL data is generated by a printer driver for the printer 2 using the interpreting unit 401 (step S703). Specifically, the printer 2 judges whether the PDL data is generated by the printer driver according to a printer driver name, an identifier, etc. described in the PDL data using the interpreting unit 401. When the PDL data is generated by the printer driver for the printer 2 (“Yes” at step S703), since it is unnecessary to convert parameter values, the printer 2 skips subsequent processings at steps S704 to S706.

On the other hand, when it is judged at step S703 that the PDL data is not generated by the printer driver for the printer 2 (“No” at step S703), the printer 2 extracts parameter values of environment variables from the PDL data using the interpreting unit 401 (step S704).

Subsequently, the printer 2 converts the parameter values extracted into parameter values corresponding to the printer 2 with reference to the conversion table 407 using the converting unit 402 (step S705). Specifically, the converting unit 402 checks whether the parameter values extracted by the interpreting unit 401 are registered in the conversion table 407. When the parameter values are registered in the conversion table 407, the converting unit 402 replaces the extracted parameter values with parameter values after conversion, which are associated with the extracted parameter values, by the conversion table 407. The printer 2 judges whether conversion processing at step S705 is completed for all the extracted parameter values (step S706).

When it is judged that the conversion processing is completed for all the extracted parameter values (“Yes” at step S706), the printer 2 judges whether selection of a designated tray is stopped or automatic sheet selection is designated in the PDL data using the print processing unit 403 (step S707). When the selection of the designated tray is stopped or the automatic sheet selection is designated in the PDL data (“Yes” at step S707), the print processing unit 403 neglects the parameter value designating the sheet feeding tray and searches for and selects a sheet feeding tray in which sheets of the same size as the sheet size in the PDL data are stored (step S708). The printer 2 sets the parameter values of the sheet discharge tray, the font, the form overlay, and the like (if the parameter values are converted, sets parameter values after conversion) and performs the print processing (step S709).

For example, it is assumed that selection of the designated tray is stopped or the automatic sheet selection is designated at the operation panel 30. In this case, even if the sheet feeding tray 1 is designated in the PDL data, the print processing unit 403 judges that the automatic sheet selection is to be performed and searches for a tray according to sheet size via the image-processing main control unit I/F 13.

On the other hand, when it is judged that the selection of the designated tray is not stopped or the automatic sheet selection is not designated in the PDL data (“No” at step S707), the printer 2 sets parameter values of the sheet feeding tray, the sheet discharge tray, the font, the form overlay, and the like (when the parameter values are converted, sets parameter values after conversion) and performs the print processing (step S709).

For example, it is assumed that there are three sheet feeding trays in the sheet feeding unit 23 of the printer 2. A setting for interpreting designation of the sheet feeding tray 1 as the sheet feeding tray 2 is registered in the conversion table 407 in advance. This is registered by a user on a screen for setting environment variable parameter conversion displayed at the host computer 1. When a parameter value of a sheet feeding tray 1 in PDL data is “11”, the converting unit 402 converts the parameter value of the sheet feeding tray 1 to “12” that indicates the sheet feeding tray 2, so that the sheet feeding tray 2 is set in the image forming unit 20. Consequently, sheets are fed from the sheet feeding tray 2 regardless of the fact that the sheet feeding tray 1 is designated in the PDL data.

The print processing is performed as described below. When page rendering is completed, the printer 2 transfers PDL data (apparatus control information and rendering data) to the image forming unit 20 through the image-processing main control unit I/F 13 using the print processing unit 403. The image-processing main control unit 21 gives sheet feeding tray information to the plotter unit 22, feeds a sheet, visualizes the rendering data to obtain an image, transfers and fixes an image on the sheet fed, and discharges the sheet.

Processing for setting the conversion table 407 is explained below. The conversion table 407 is set by the user in advance from the host computer 1. The printer 2 transmits a screen for setting environment variable parameter conversion to the host computer 1 on the network using the WEB server function unit 404. The host computer 1 displays the screen for setting environment variable parameter conversion received on the WEB browser.

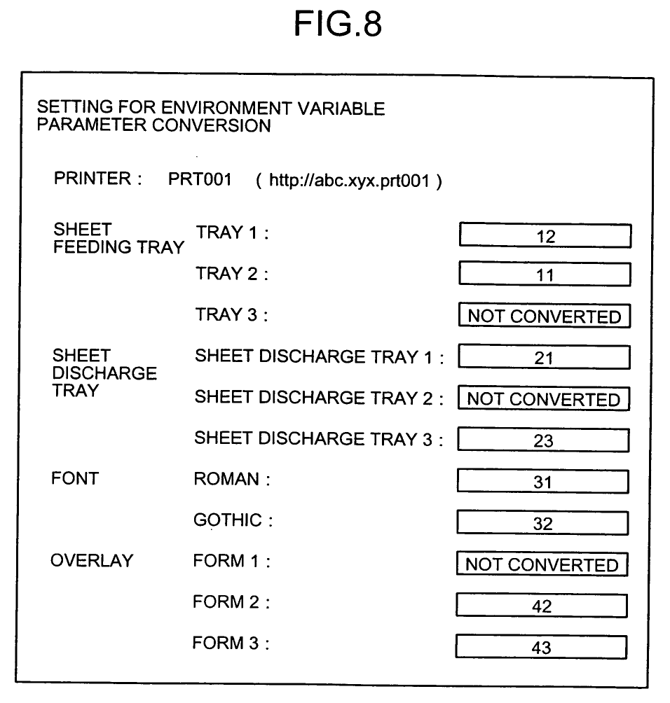

FIG. 8 is a schematic of an example of the screen for setting environment variable parameter conversion displayed on the WEB browser. In the example shown in FIG. 8, the contents of the conversion table 407 in FIG. 6 are set. A parameter value after conversion is entered in an input field for each type of environment variables such as a sheet feeding tray and a sheet discharge tray. “Not converted” is entered for a parameter value that is not required to be changed.

When a parameter value is inputted and transmitted from the host computer 1 via the screen for setting environment variable parameter conversion, the printer 2 receives the parameter value using the WEB server function unit 404. The printer 2 registers the parameter value as a parameter value after conversion of a parameter value of a corresponding environment variable in the conversion table 407.

Note that, in this embodiment, the conversion table 407 is set from the host computer 1. However, the printer 2 can display the screen for setting environment variable parameter conversion on the liquid display unit of the operation panel 30 of the printer 2 using the setting unit 405, and a user can register a parameter value to the conversion table 407 from the operation panel 30.

Note that the print processing program executed by the printer 2 is stored in the ROM 15 in advance. However, the print processing program executed in the printer can be recorded in a computer readable recording medium such as a CD-ROM, a flexible disk (FD), a CD-R, or a Digital Versatile Disk (DVD) as a file of an installable format or an executable format.

The print processing program executed by the printer 2 can be stored on a computer connected to a network such as the Internet and downloaded through the network. The print processing program executed by the printer 2 can be provided or distributed through the network such as the Internet.

The print processing program executed by the printer 2 is constituted as a module including the units described above (the interpreting unit, the converting unit, the print processing unit, the WEB server function unit, and the setting unit). In terms of hardware, a CPU (a processor) reads out the print processing program from the ROM 15 and executes the print processing program, whereby the units are loaded on a main storage such as the RAM 17. Consequently, the interpreting unit, the converting unit, the print processing unit, the WEB server function unit, and the setting unit are generated on the main storage.

As described above, the printer 2 interprets PDL data received from the host computer 1 connected to the printer 2 through the network 18 and extracts parameter values, which are specific information of environment variable parameters defining printing conditions in the printer 2, described in the PDL data. Then, the printer 2 converts the parameter values according to the conversion table 407 that associates the parameter values with parameter values corresponding to a printer before being replaced with the printer 2 (conversion parameter information) to perform print processing. Thus, even if a model of the printer 2 is changed without changing a printer driver, a printing operation is not affected by a difference in parameter values between the printers. Therefore, it is possible to perform print processing under the same conditions as the printer that has been used, thus improving convenience for a user.

The printer 2 can be configured to set a correlation between the parameter values of the sheet feeding tray and command interpretation in advance. This makes it possible for a user to select an arbitrary combination of the parameter values. In addition, the printer 2 can be configured to perform automatic sheet selection even when a sheet feeding tray is designated. This makes it possible to set operation conditions in designating a sheet feeding tray.

In this manner, the image forming apparatus interprets image formation data received from an information processing apparatus connected to the image forming apparatus through the network, extracts parameter information, which is specific information on environment variable parameters defining conditions concerning image formation in the image forming apparatus, described in the image formation data, converts the parameter information extracted into conversion parameter information by a conversion table. The conversion table associates the parameter information with conversion parameter information that is parameter information corresponding to another image forming apparatus. Further, the image forming apparatus sets the conversion parameter information to perform image formation processing. Consequently, even when a user replaces the image forming apparatus with another image forming apparatus of a different model without changing a printer driver, an image forming operation is never affected by a difference in parameter information. Thus, it is possible to perform image formation processing under the same conditions as that of the image forming apparatus used before the replacement. As a result, it is possible to improve convenience of use for the user.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a storing unit that stores therein information including a first parameter concerning the image forming apparatus associated with a second parameter concerning another image forming apparatus;
an extracting unit that extracts a parameter from data received from an information processing apparatus;
a converting unit that converts, when the parameter extracted by the extracting unit corresponds to the second parameter, extracted parameter to the first parameter based on the information stored in the storing unit; and
an image formation unit that performs image formation according to the first parameter.

2. The image forming apparatus according to claim 1, further comprising a plurality of sheet feeding trays, wherein the extracted parameter, the first parameter, and the second parameter define a sheet feeding tray.

3. The image forming apparatus according to claim 2, wherein
each of the plurality of sheet feeding trays are configured to store therein recording mediums of different sizes, and
the extracted parameter, the first parameter, and the second parameter define a size of a recording medium.

4. The image forming apparatus according to claim 2, wherein
the data includes a command to automatically select a recording medium, and
the image formation unit performs the image formation on a recording medium specified in the command.

5. The image forming apparatus according to claim 1, further comprising a plurality of sheet discharge trays, wherein the extracted parameter, the first parameter, and the second parameter define a sheet discharge tray.

6. The image forming apparatus according to claim 1, wherein the extracted parameter, the first parameter, and the second parameter define a font.

7. The image forming apparatus according to claim 1, wherein the extracted parameter, the first parameter, and the second parameter define a form.

8. The image forming apparatus according to claim 1, further comprising:
an obtaining unit that obtains the first parameter and the second parameter from the information processing apparatus; and
a setting unit that sets the first parameter and the second parameter obtained by the obtaining unit.

9. The image forming apparatus according to claim 1, further comprising:
a receiving unit that receives the first parameter and the second parameter; and
a setting unit that sets the first parameter and the second parameter received by the receiving unit.

10. A method of forming an image, comprising:
storing information including a first parameter concerning an image forming apparatus associated with a second parameter concerning another image forming apparatus;
extracting a parameter from data received from an information processing apparatus;
converting, when the parameter extracted at the extracting corresponds to the second parameter, extracted parameter to the first parameter based on the information stored at the storing; and
performing image formation according to the first parameter.

11. The method according to claim 10, wherein
the performing includes selecting a sheet feeding tray from among a plurality of sheet feeding trays based on the first parameter.

12. The method according to claim 11, wherein
the performing includes selecting a size of a recording medium from among recording mediums of different sizes based on the first parameter.

13. The method according to claim 11, wherein
the data includes a command to automatically select a recording medium, and
the performing includes performing the image formation on a recording medium specified in the command.

14. The method according to claim 10, wherein
the performing includes selecting a sheet discharge tray from among a plurality of sheet discharge trays based on the first parameter.

15. The method according to claim 10, wherein
the performing includes performing the image formation based on a font defined by the first parameter.

16. The method according to claim 10, wherein
the performing includes performing the image formation based on a form defined by the first parameter.

17. The method according to claim 10, further comprising:
obtaining the first parameter and the second parameter from the information processing apparatus; and
setting the first parameter and the second parameter obtained at the obtaining.

18. The method according to claim 10, further comprising:
receiving the first parameter and the second parameter; and
setting the first parameter and the second parameter received at the receiving.

19. A computer-readable recording medium that stores therein a computer program that causes a computer to execute:
storing information including a first parameter concerning an image forming apparatus associated with a second parameter concerning another image forming apparatus;
extracting a parameter from data received from an information processing apparatus;
converting, when the parameter extracted at the extracting corresponds to the second parameter, extracted parameter to the first parameter based on the information stored at the storing; and
performing image formation according to the first parameter.
